(19) United States
(12) Patent Application Publication
(10) Pub. No.: US 2010/0287741 A1
(43) Pub. Date: Nov. 18, 2010

(54) MAGNETVERSCHLUSS

(76) Inventor: Joachim Fiedler, Berlin (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 12/373,389

(22) PCT Filed: Jul. 12, 2007
(86) PCT No.: PCT/DE07/01240

§ 371 Date: Feb. 5, 2010

(30) Foreign Application Priority Data
Jul. 12, 2006 (DE) 102006032522.2
Jul. 5, 2007 (DE) 102007031398.7

(51) Int. Cl. H01F 7/02; A45C 13/10

(52) U.S. Cl. 24/303

(57) ABSTRACT

The invention relates to a magnetic locking device for closing preferably handbags and similar objects. The magnetic locking device comprises connecting modules each provided with a guide piece having a tubular or trough-like cross section, wherein the guide pieces are formed so as to be fittable into one another, and permanent magnets are arranged at the bottoms thereof, wherein the permanent magnet in the guide piece 1 is fixedly arranged and the permanent magnet in the guide piece 2 is movably arranged so that, when the device is closed, it is automatically adjusted to the other permanent magnet and brought into an attraction position.

The invention relates to a magnetic locking device for locking hand bags and similar objects, preferably. Such locking devices are sufficiently known from the prior art.

However, such locking devices comprise an unsatisfactory haptics, because, due to the greatly nonlinear course of the magnetic attractive forces, opening of the locking device by hand can be done jerkily only. Therefore, it is a steady requirement to improve the opening and closing properties of such locking devices, but in addition, the locking devices must be formed so that the data on credit cards are not erased.

Therefore, object of the invention is to provide a magnetic locking device which comprises a reliable function and an agreeable haptics, and moreover, does not erase the data stored on credit cards.

This problem is solved by a magnetic locking device according to claim 1. This magnetic locking device has two connecting modules for connecting two elements with each other, with one each of the connecting modules being fixable to these elements and comprising at least one permanent magnet. In addition, a tubular or trough-like guide piece is arranged in each of the connecting modules. However, the term tubular is not restricted to circular. The cross section can freely be chosen and be symmetric or non-symmetric in shape. Merely, it has to be considered that the guide pieces are formed so that they can be fitted into one another. The same is true for trough-like guide pieces.

The permanent magnets are arranged on the bottoms of the guide pieces, wherein the permanent magnet in the guide piece 1 is fixedly arranged, whilst the permanent magnet in the guide piece 2 is movably arranged so that it will be automatically aligned to the other one into an attracting position when the locking device is closed.

The invention comprises the following advantages:

Due to the guide pieces being fittable into one another, the locking device can be joined easily. As the magnets are arranged within the guide pieces, any credit card sensitive to magnets can not be damaged. When the magnets attract each other, an individual senses a wanted haptic feeling. This feeling gives the impression that the locking device itself closes automatically and safely. Also, a wanted haptic feeling is given when the locking device is opened. This feeling gives the impression that the locking device apparently opens automatically, as the magnetic repulsive forces softly separate the modules from each other—in contrast to a jerky opening procedure as known from the most of the locking devices of this kind according to the prior art. In order that the magnetic locking device according to the invention works reliably, any technical measure must be provided, by which the magnetic shearing forces generated with the opening procedure are received. These shearing forces are received by the guide pieces fitted into one another. Therefore, the guide pieces have a dual function, that is, they serve as distance holders for a credit card and as thrust for the magnetic shearing forces generated with the opening procedure.

According to claim 2, the guide pieces comprise rounded-off or chamfered edges to facilitate fitting them into one another.

According to claim 3, the guide pieces comprise a backlash to facilitate fitting them into one another.

According to claim 4, at least one ferromagnetic armature is arranged in addition to the permanent magnet so that, in the closed state of the locking device, the permanent magnet touches the ferromagnetic armature and, for the opening process, the permanent magnets are movable to a repulsive position.

According to claim 5, the guide pieces are made of a ferromagnetic material, whereby a further shielding of the magnetic field is gained so that the danger of damaging any credit card is still further reduced.

According to claim 6, the guide pieces have a circular cross section. Therefore, especially simple structures can be created.

According to claim 7, the movable magnet is provided with a resetting element. This resetting element facilitates the operation of the locking device.

According to claim 8, the resetting element is a mechanical spring. This embodiment is especially cost-effective.

According to claim 9, the resetting element is a magnet polarized for repulsion. This embodiment comprises an especially good haptics.

According to claim 10, the resetting element is a weight which, due to its mass, pushes the movable magnet to its home position when the magnetic locking device is brought into a predetermined spatial position. This embodiment is especially cost-effective.

Below, the invention will be explained in detail by means of a practical example and the accompanying drawings.

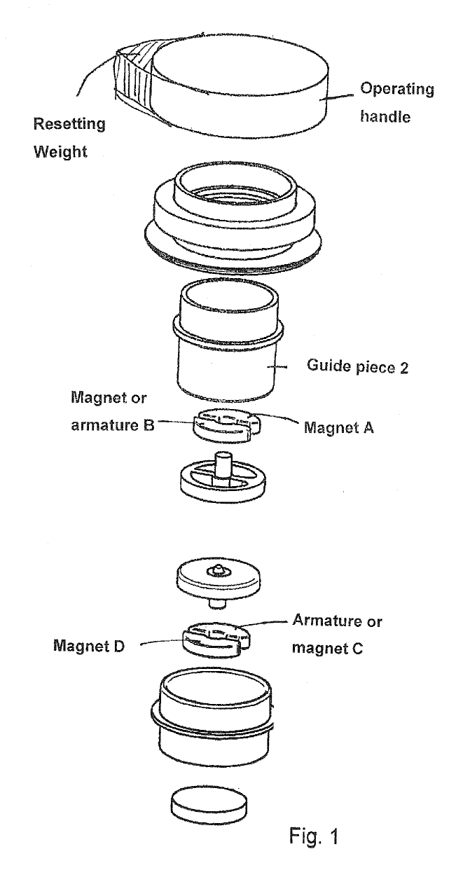

FIG. 1 is an exploded view of a first embodiment of the invention

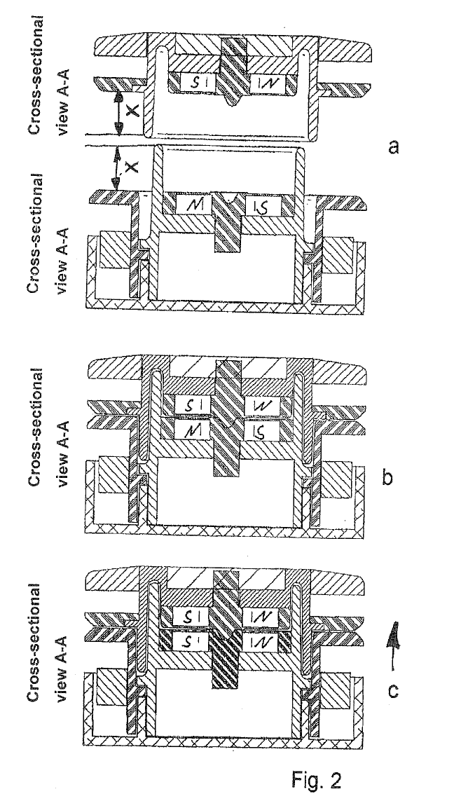

FIG. 2 is a cross-sectional view of the embodiment shown in FIG. 1.

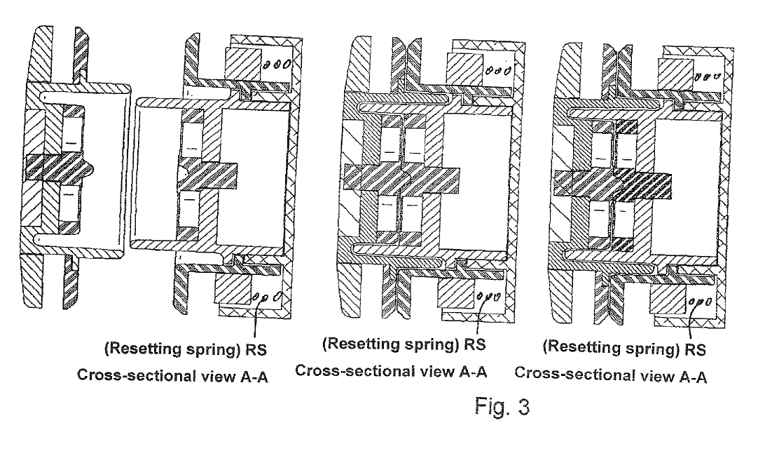

FIG. 3 is a cross-sectional view of the embodiment shown in FIG. 1, which is provided with a spring for setting spring.

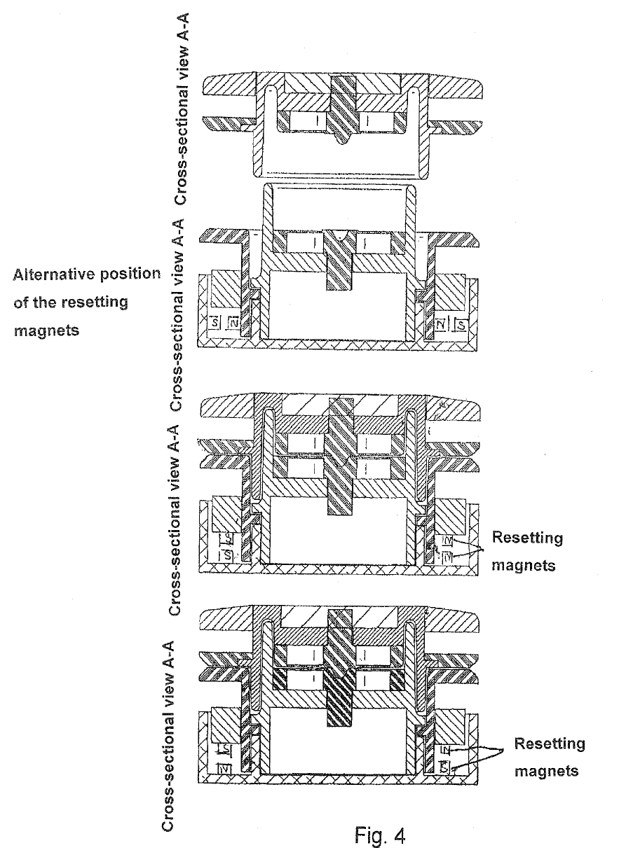

FIG. 4 is a cross-sectional view of the embodiment shown in FIG. 1, which is provided with a magnet for resetting.

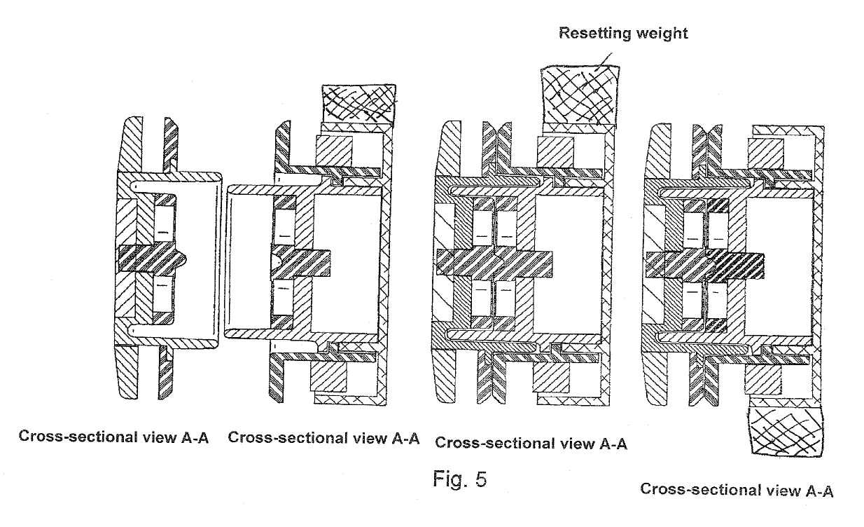

FIG. 5 is a cross-sectional view of the embodiment shown in FIG. 1, which is provided with a weight for resetting.

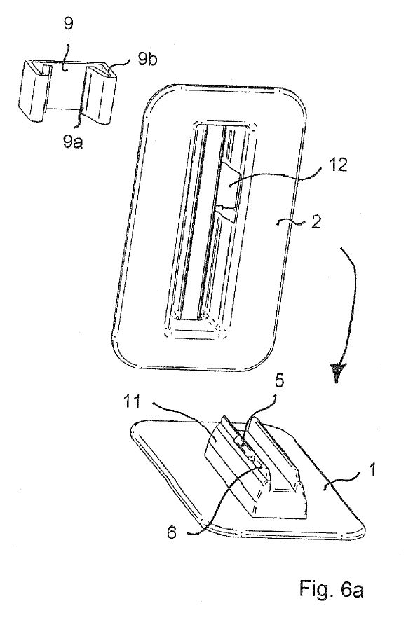

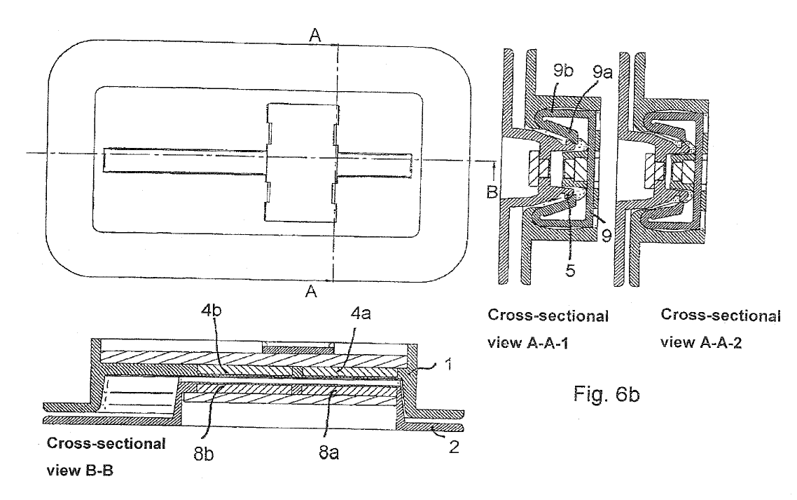

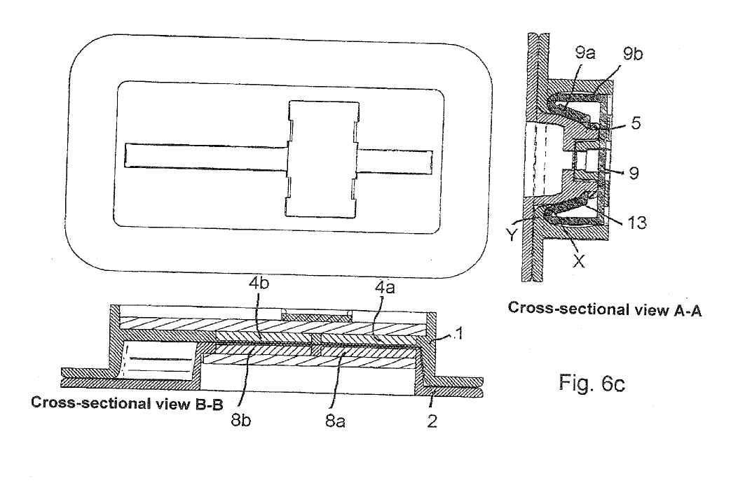

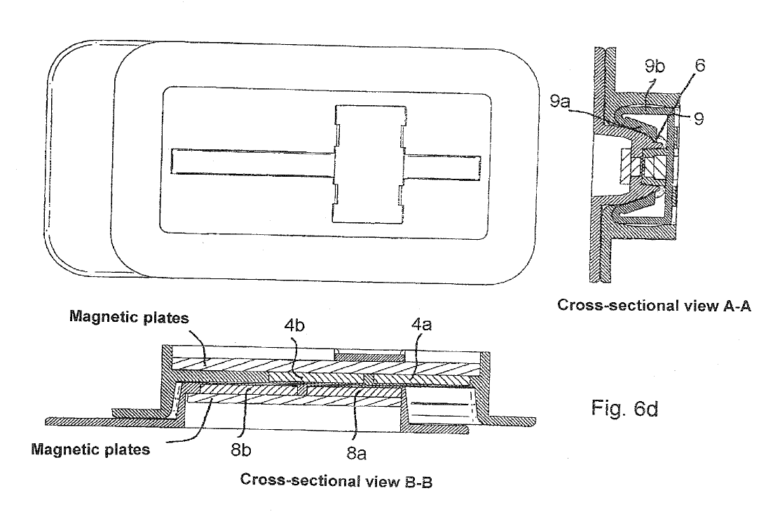

FIG. 6 shows a second embodiment of the invention.

Proceeding from FIGS. 1 and 2, the locking device according to the invention comprises a polarizable magnet system, which, when turned, closes and opens by magnetic forces. According to the invention, the magnets are arranged on the bottom of each of the tubular guide pieces. As shown in the cross-sectional views, the magnets are marked by N and S, respectively. In the position marked by c, homopolar magnets are opposite to one another so that the locking device opens automatically, that is, the upper part is repelled in the direction marked by an arrow. As shown in the cross-sectional view a, the magnets are arranged at a distance x from the upper edge of each of the tubular guide pieces. This distance was chosen so that credit cards are not damaged. Furthermore, the drawings show that the guide pieces are slightly rounded at their upper edges so that they fit into one another very well. When the locking device is in the closed state, the tubular guide pieces project into the recesses of the respective counterpart so that the magnets attracting each other are close to one another.

FIG. 3 is a cross-sectional view of the embodiment shown in FIG. 1, which is provided with a resetting element in the shape of a spring RS for resetting the locking device into its home position.

FIG. 4 is a cross-sectional view of the embodiment shown in FIG. 1, which is provided with resetting element in the shape of a magnet for resetting the locking device into its home position.

FIG. 5 is a cross-sectional view of the embodiment shown in FIG. 1, which is provided with a resetting element in the shape of weight for resetting the locking device into its home position gravimetrically. This embodiment is used where a defined spatial mounting situation is given, at a cupboard, for example.

FIG. 6 show a locking device which carries out a rectilinear opening movement. FIG. 6a is a perspective view of the substantial constituents of this locking device. The locking device is composed of the connecting modules 1 and 2 which are fixed to a bag. On principle, fixing can be done in different kinds and ways, by sewing, sticking, riveting or screwing, for example. An expert skilled in this field knows how to fix products of this kind, and therefore, fixing will not further be explained in the description of the following embodiments. The connecting module 1 is formed as plug having a wedge-like plug-in section 11 which extends in lengthwise direction thereof. The plug-in section 11 is provided with a fixed arresting piece 5 having an interstice 6. A separately shown flexible locking element 9 is inserted into the recess 12 marked by an arrow. The magnets are shown in the other figures.

FIG. 6b shows two cross-sectional views A-A, from which it is recognizable how the connecting modules lock themselves with each other. In the state shown in the cross-sectional view A-A-1, the flexible locking element 9 rests on the arresting piece 5. This state corresponds to the operation phase shown in FIG. 1b. In the state shown in the cross-sectional view A-A-2, the flexible locking element 9 has already been bent back. This state corresponds to the operation phase shown in FIG. 1c.

The positions of the magnets and of the armatures made of a ferromagnetic material are recognizable from the cross-sectional view B-B. An expert skilled in this field knows that the armatures 8 can also be magnets. The positions of the magnets and the armatures must be determined by an expert so that, as shown in the cross-sectional view B-B, both the connecting modules attract each other, that is, either two magnets attracting each other or a magnet and an armature must be positioned opposite to each other. For example, when magnets 4a and 4b are positioned opposite to magnetic armatures 8a and 8b and attract each other, the magnets 4 and the magnetic armatures 8 are of different denomination. When the magnets 4 and the magnetic armatures 8 are displaced to each other, surfaces having the same polarity are positioned opposite to, and therefore, repel each other, which will be understood when the separation of the connecting modules is described.

FIG. 6c is the same as FIG. 6b, with the difference that the flexible locking element 9 and the arresting piece 5 are locked with each other, recognizable from the cross-sectional view A-A. That is, the locking device is closed. It must be mentioned that the flexible locking element 9 is supported on its total surface by the supporting area 13 and is almost exclusively stressed by pressure when the assembly is loaded, whereby the assembly becomes very stable.

FIG. 6d shows the opening procedure, with which the connecting module 2 is displaced to the left side. That is, the flexible locking element 9 is positioned opposite to the interstice 6 and therefore, is not engaged with the arresting piece 5 any more. Displacing of the connecting module 2 also causes the magnet-armature unit 4/8 to be displaced. As shown in FIG. 6d, magnetic guide plates are arranged behind the magnets. In this practical example, the magnetic guide plates serve to improve the utilization of the magnetic force by short-cutting the magnetic fields emerging from the backside and to shield the content of a bag, such as credit cards, from unwanted magnetic fields.

It can also be seen from the drawings that the magnets are arranged in recesses and the guide pieces are formed so that the locking device halves are reliably joinable.

1. Magnetic locking device having two connecting modules for connecting two elements to which one each of the connecting modules is fixable, wherein at least one permanent magnet is arranged in each of the connecting modules and wherein the magnetic attraction between the modules is at least attenuated by a turning or dislocating movement, characterized in that
each of the connecting modules comprises a tubular or trough-like guide piece, wherein the guide pieces are formed so as to be fittable into one another and
the permanent magnets are arranged in the bottom area of the guide pieces.

2. Magnetic locking device according to claim 1, characterized in that the guide pieces comprise chamfered or rounded edges to facilitate fitting them into one another.

3. Magnetic locking device according to claim 1, characterized in that the guide pieces comprise a backlash to facilitate fitting them into one another.

4. Magnetic locking device according to claim 1, characterized in that at least one ferromagnetic armature is arranged in addition to the permanent magnet so that, in the closed state of the device, the permanent magnet abuts to a ferromagnetic armature and, for opening the device, the permanent magnets are turnable into a repulsion position.

5. Magnetic locking device according to claim 1, characterized in that the guide pieces are made of a ferromagnetic material.

6. Magnetic locking device according to claim 1, characterized in that the guide pieces have a circular cross section.

7. Magnetic locking device according to claim 1, characterized in that the movable magnet is provided with a resetting element.

8. Magnetic locking device according to claim 7, characterized in that the resetting element is a mechanic spring.

9. Magnetic locking device according to claim 7, characterized in that the resetting element is magnet polarized for repulsion.

10. Magnetic locking device according to claim 7, characterized in that the resetting element is a weight which, due to its mass, pushes the movable magnet into its home position when the device is brought into a predetermined spatial position.
